(19) United States
(12) Patent Application Publication
(10) Pub. No.: US 2016/0188676 A1
(43) Pub. Date: Jun. 30, 2016

(54) COLLABORATION SYSTEM FOR NETWORK MANAGEMENT

(71) Applicant: Firemon, LLC, Overland Park, KS (US)

(72) Inventors: Jeffrey Barker, Los Altos, CA (US); Michael Morford, Foster City, CA (US); Darren Christopher Tom, San Jose, CA (US)

(73) Assignee: Firemon, LLC, Overland Park, KS (US)

(21) Appl. No.: 14/973,092

(22) Filed: Dec. 17, 2015

Related U.S. Application Data
(60) Provisional application No. 62/098,235, filed on Dec. 30, 2014.

(51) Int. Cl. G06F 17/30; H04L 12/923

(52) U.S. Cl. CPC G06F 17/30545; G06F 17/30525; G06F 17/30528; G06F 17/30864; H04L 47/762

(57) ABSTRACT

Aspects of the present disclosure involve systems and methods for integrating human and machine sourced data from a computing network into a shared database. The human and machine sourced data is available by one or more network administrators to allow the administrators to collaborate within the combined data set to create and execute one or more solution workflows to respond to events occurring within the network. In one embodiment, the human and machine sourced data is stored in the database as a single data set. In this manner, the data or network information may be searched collectively through one search query applied to the stored data.

### RELATED APPLICATIONS

This application claims priority under 35 U.S.C. §119(e) to U.S. Provisional Application No. 62/098,235 entitled “COLLABORATION SYSTEM FOR HUMAN AND MACHINE SOURCED DATA”, filed on Dec. 30, 2014 which is incorporated by reference in its entirety herein.

### TECHNICAL FIELD

Aspects of the present disclosure relate generally to management of a network of computing devices, and more particularly to collecting and analyzing machine generated and human generated information of the network of computing devices for monitoring the performance of the network.

### BACKGROUND

Large networks of interconnected computing devices or components are becoming more and more common. The “Internet” or the World Wide Web (the “Web”) may be considered such a computing network that is easily accessible using numerous possible computing devices. In general, any network of interconnected computing devices that communicate among each other to convey information between the devices and/or users of the network may be considered a large network. Such networks may be available to the public (such as the Internet) or may be privately managed (such as networks owned and operated by corporations or other network administrators). For many networks, one or more administrators, managers, and/or network engineers may monitor or otherwise manage the performance of the network and network devices to ensure proper operation of the network.

Monitoring a network performance may include log collection/analytics products deployed in the network to receive and process events and data generated by the devices of the network. Such collection products generally receive packets of information from one or more of the components of the network in response to events that occur within the network. For example, a server of the network may experience of a high volume of traffic and, in response, provide an indication of the high volume of traffic to a collection product. In other examples, the component may provide a report of one or more operating statuses of the component. This information may be gathered by the collection products and presented to an administrator of the network. In response to a detected and reported event, the administrator may perform one or more remediation procedures to ensure the proper operation of the network. In this manner, a Network Operation Center (NOC) with one or more network administrators may monitor the performance of the network and respond to events that occur within the network.

It is with these observations in mind, among others, that various aspects of the present disclosure were conceived and developed.

### SUMMARY

One implementation of the present disclosure may take the form of a system for managing a computer network. The system may include a communication port for communication with one or more devices of the computer network and one or more third party systems, a collector component receiving machine sourced information from the one or more devices of the computer network and human sourced information from the one or more third party systems, and a database storing the machine sourced information and the human sourced information in data set of network information, the data set of network information comprising at least one metadata identifier corresponding to a network event. The system may also include a collaboration component accessing the data set of network information of the combined machine sourced information from the one or more devices of the computer network and the human sourced information from the one or more third party systems and providing the data set of network information to a user.

Another implementation of the present disclosure may take the form of a method for managing a network of computing devices. The method includes the operations of receiving, at a collector component of a network management system, machine sourced information from one or more devices of the network of computing devices and human sourced information from the one or more third party systems in communication with the network management system, correlating the received machine sourced information and human sourced information to a particular network event, and storing the received machine sourced information from one or more devices of the network of computing devices and human sourced information from the one or more third party systems in communication with the network management system in a database a data set of network information. The method may further include the operations receiving a search query from a user of the network management system, accessing the data set of network information of the combined machine sourced information from the one or more devices of the computer network and the human sourced information from the one or more third party systems based on the received search query, and providing the data set of network information to the user of the network management system.

### BRIEF DESCRIPTION OF THE DRAWINGS

The foregoing and other objects, features, and advantages of the present disclosure set forth herein should be apparent from the following description of particular embodiments of those inventive concepts, as illustrated in the accompanying drawings. Also, in the drawings the like reference characters may refer to the same parts throughout the different views. The drawings depict only typical embodiments of the present disclosure and, therefore, are not to be considered limiting in scope.

FIG. 1 is an example network environment for combining machine-sourced and human-sourced network information to aid in collaboration within the combined data set to create and execute solution workflows.

FIG. 2 is a flowchart of a method for receiving and storing machine-sourced and human-sourced network information in a database.

FIG. 3 is a flowchart of a method for providing combined machine-sourced and human-sourced network information to a network administrator.

FIG. 4 is an example user interface providing results of combined machine-sourced and human-sourced network information to a network administrator.

FIG. 5 is an example user interface illustrating a number of sources of data stored in a database associated with a network.

FIG. 6 is a flowchart of a method for utilizing network information to collaborate on responding to a network event

FIG. 7 is an example user interface illustrating a first example workflow for maintaining a network.

FIG. 8 is an example user interface illustrating a collection of workflows for maintaining a network.

FIG. 9 is an example user interface illustrating one or more actions initiated from a workflow for network maintenance.

FIG. 10 is an example user interface illustrating combined machine-sourced and human-sourced network information to a network administrator, including results from one or more automatic actions taken by the system in response to a workflow for network maintenance.

FIG. 11 is an example user interface providing results of a search of human-sourced network information in a collaboration feature of the user interface.

FIG. 12 is an example user interface for receiving comments in a collaboration feature of the user interface.

FIG. 13 is an example user interface for summarizing human-sourced information in a collaboration feature of the user interface.

FIG. 14 is an example of a computing system that may implement various systems, network elements, and methods discussed herein.

### DETAILED DESCRIPTION

Aspects of the present disclosure involve systems and methods for integrating human and machine sourced data from a computing network into a shared database. The human and machine sourced data is made available by one or more network administrators to allow the administrators to collaborate within the combined data set to create and execute one or more solution workflows to respond to events occurring within the network. In one embodiment, the human and machine sourced data is stored in the database as a single data set. In this manner, the data or network information may be searched collectively through one search query applied to the stored data. To facilitate the storing and accessing of the combined human and machine sourced data, the received information may be analyzed and one or more metadata tags or other identifiers may be associated with received network information prior to storing in the database. Such tags may allow the data to be searched and parsed for all information, whether data received from a particular network device or data generated by one or more network administrators, to be combined and analyzed as a single data set related to a particular event of the network.

With the combined and accessible human and machine sourced data, the system also allows for a plurality of users to explore the combined data and collaborate in responding to the event related to the information. In one embodiment, the collaboration may include the generation of additional data (both machine sourced and human sourced) that may further be included in the database and shared among the users of the system. With this information, actions to remediate or otherwise respond to a detected event within the network or within a component of the network may be performed by the system and/or the administrators utilizing the system. To aid in the execution of such actions, one or more workflows may be created and/or executed by the system during the collaboration utilizing the combined dataset. Such workflows may include actions performed automatically by the system in response the detected event as well as actions performed by one or more of the administrators of the network. In one embodiment, one or more workflows may be altered or amended based on noted successes of previous workflows addressing similar events in the network. Thus, through this collaboration and workflow process, the system may identify an event in the network and undertake one or more actions to address the identified event.

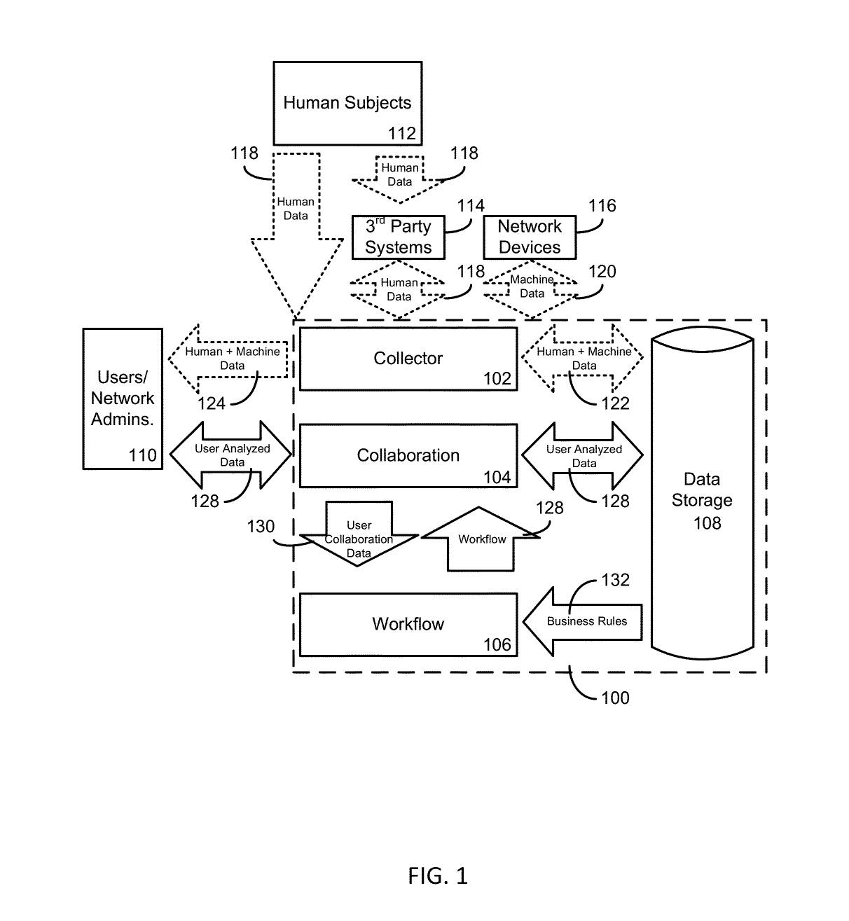

FIG. 1 is an example network environment for combining machine-sourced and human-sourced network information to aid in collaboration within the combined data set to create and execute solution workflows. The environment includes a system 100 for collecting and storing information concerning a network of interconnected computing devices. Such information may include machine sourced information 120 (such as alerts and/or logs provided by the devices in the network) and/or human sourced information 118 (such as emails, instant messages (IMs), documents, transcripts, and the like). Further, the system 100 may provide the combined data set to one or more users of the system to aid the users in collaborating in generating and executing one or more workflows to address events occurring on the network. Although illustrated in FIG. 1, the system 100 may include certain components and sub-systems. However, it should be appreciated that any sub-system may include any number and type of sub-components for performing the functions of the components. In addition, more components may also be included in the system 100, although not specifically illustrated in FIG. 1. As described in more detail below, the system 100 may be embodied on or otherwise include a computing system for performing the operations discussed herein.

As mentioned, the system 100 provides for the collection and storing of data and/or other information concerning a computing network. To facilitate this feature, the system 100 includes a collector component 102. In general, the collector 102 receives information concerning one or more of the devices of the network, collects or otherwise correlates the received data through the use of tags, and stores the data in a shared database 108. As such, the collector 102 of the system 100 is in communication with one or more devices 116 of the network, one or more sources of human sourced data 118, and the database 108 for storing the information. As shown in FIG. 1, the devices of the network (illustrated as the monitored devices 116) provide information 120 or machine data to the collector 102. The information or data 120 provided by the monitored network devices 116 may be any output from the device. Such information 120 may be transmitted to the collector 102 in response to a query from the collector or in response to any event occurring on the network. The data 120 may be syslogs, packet capture, threat reputation, security events, performance statistics, environmental measurements, mechanical failure alerts, and the like. In other embodiments, the data 120 may be provided by an application server of the network. In still other embodiments, the network may include any number of sensor devices such that the machine data 120 may be files from remote sensors. For other network types, the machine data 120 may include transaction records and/or audit logs from a medical Electronic Medical Records (EMR) system, an Enterprise Resource Planning (ERP) system, a Human Resource (HR) system and/or a Customer Relationship Manager (CRM) system.

In addition to the data from one or more devices 116 in a network, the collector 102 may receive human sourced data from one or more administrators or other users of the network. As illustrated in FIG. 1, one or more human subjects 112 provide human sourced data 118 to the collector 102. Such information may be provided directly to the collector 102 through one or more interfaces to the system 100, or may be provided to the collector through one or more third party systems 114. For example, the human sourced data 118 may be an email provided to the system from a user 112 through an email program 114, online or shared social media services, applications that source information from users emails, chats, document management systems, ratings, surveys, health and medical devices, and the like. In general, the human sourced information 118 may be any data or information provided to the system 100 by a user 112. Such human sourced information 118 may include, but is not limited to: bug, issue or ticket tracking, contact management, customer databases, email, documents, spreadsheets, presentations, transcripts, wikis, blogs, social media platforms, payment platforms, mobile devices, security sensor devices, video or still cameras, microphones, scales, implanted medical devices, GPS trackers, wearable biometric monitors, identification devices. Such information may be directly provided through third party systems 114 using the GUI or CLI of the system and may be directly associated with the machine data 120. Other human sourced information 118 may be indirectly provided to the system 100, including command history and time, query history, problem resolution speed, use of system features (bookmarks, tags, etc.), collaboration usage (session participation and following), and the like.

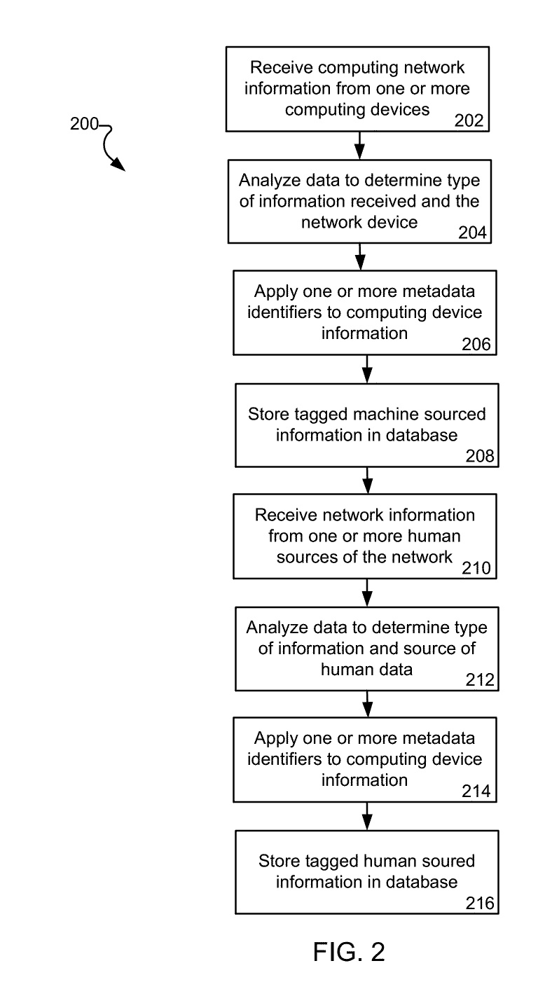

As mentioned above, the information received at the collector 102 of the system 100 may be stored in a database 108. Thus, the collector 102 may transmit the received information concerning the network 122 to the database 108 for storage. Such information 124 may also be provided to a user 110 of the system 100, as explained in more detail below. To combine the machine sourced data 120 and the human sourced data 118 into the stored data 122, the system 100 (and in one particular embodiment, the collector 102) may sort the information and attach or otherwise associate one or more identifiers to the received data. Such identifiers may aid the system 100 in storing related information together and retrieving related information from the database 108 in response to a search query provided to the system from a user 110. FIG. 2 is a flowchart of a method for receiving and storing machine-sourced and human-sourced network information in a database. Through the operations of the method 200 of FIG. 2, the received information may be analyzed, sorted, categorized, and stored by the system 100 for use by users 110 of the system. The operations of the method 200 may be performed by any component of the system 100. In one particular embodiment, the collector 102 of the system 100 performs one or more of the operations of the method 200.

Beginning in operation 202, the collector 102 receives machine sourced network information or data 120 from one or more computing devices 116 connected to or otherwise included in the network. In operation 204, the collector 102 analyzes the data to determine the type of information and from which devices of the network 116 the information is received. Such analysis may include a general word search of the information, parsing the information for known fields or strings of data, determining the IP address associated with the data and/or from which the data is received, and the like. In general, the collector 102 may determine the type of data (alerts, responses to queries transmitted to the devices, general operational information, status updates, etc.), the device from which the information is received, and the relationship of the particular device to the network.

After the machine sourced data is analyzed, the collector 102 associates one or more identifiers or metadata to the information or data set in operation 206. The metadata associated with the received data may be used to aid in parsing, storing, and/or retrieving the information from the database 108, as explained in more detail below. Other processing of the information may also be performed by the collector 102. For example, tagging, transliteration, summarizing, deduplicating, and/or use of additional metadata associated with the data may be applied to the data during the data processing. In one embodiment, such metadata may be stored in an inverted form to allow rapid retrieval of matching or similar data represented by the metadata. In another embodiment, linked machine data may be transliterated to provide more readable output prior to storing in the database 108. In yet another embodiment, a dictionary of common machine tokens can be generated. Any common machine tokens on that list (in one example, usernames or IP addresses) can be assembled into a separate metadata field or separate token list. Using the metadata or tokens, searches can then weight the scoring higher or lower as explained in more detail below. In operation 208, the received information and any processed or generated metadata may be stored in the database 108 for use by one or more network administrators in collaboration in managing the network.

In operations 210 through 216, the collector 102 may perform similar operations on the human sourced data 118 received either directly to the system 100 (such as through a user interface) or through a third party system 114. Thus, in operation 210, the collector 102 receives human sourced network information or data 118 from one or more human connected sources 114. In operation 212, the collector 102 analyzes the human sourced data to determine the type of information and to any network devices or events to which the data may relate. For example, an email may be sent from a network administrator discussing an alert generated by a switch in the network. The email may identify the switch by IP address or other addressing feature. Through an analysis of the email, the collector 102 may identify that the email is related to the alert event generated by the network device and associate the email with the network event accordingly. Other types of human sourced data, such as documents, spreadsheets, issue or ticket tracking info, workflows, etc. may similarly be analyzed and associated with one or more network devices or network events. The relation of the human sourced data to a network device or network event may be obtained through a general word search of the information, parsing the information for known fields or strings of data, determining the IP address associated with the data and/or from which the data is received, and the like.

In operation 214, the collector 102 associates one or more identifiers or metadata to the human sourced information or data set. Similar to the machine sourced data, the metadata associated with the received human sourced data may be used to aid in parsing, storing, and/or retrieving the information from the database 108, as explained in more detail below. Other processing of the information may also be performed by the collector 102. For example, tagging, transliteration, summarizing, deduplicating, and/or use of additional metadata associated with the data may be applied to the data during the data processing. In one embodiment, such metadata may be stored in an inverted form to allow rapid retrieval of matching or similar data represented by the metadata. In another embodiment, linked machine data may be transliterated to provide more readable output prior to storing in the database 108. In yet another embodiment, a dictionary of common machine tokens can be generated. Any common machine tokens on that list (in one example, usernames or IP addresses) can be assembled into a separate metadata field or separate token list. Using the metadata or tokens, searches can then weight the scoring higher or lower as explained in more detail below. In operation 216, the received information and any processed or generated metadata may be stored in the database 108 for use by one or more network administrators in collaboration in managing the network.

In one embodiment, the processing of the information includes executing analytics over the collected data to provide targeted output or metadata that is stored in the logical data set. The metadata for this information may include, but is not limited to: linkage of one or more human generated data points to one or more machine generated data points and state or context based on local domain specific rules.

Through the operations above, the processed network data 122, both machine sourced and human sourced, is stored in the database 108. In one embodiment, the data is not stored separately in the database based on the source of the information. Rather, all data and/or information received is processed in the same manner and stored in the database 108 as a single dataset. Further, the system 100 may allow access to the stored information by one or more users 110 of the system. In general, the system 100 receives an input from the one or more users 110 of the system that indicate which stored data is requested by the user. In response, the system 100 retrieves the requested information 124 provides the information to the users 110. In one particular embodiment, the information is provided to the users 110 through a user interface of the system 100 operating on a terminal or other computing device of the system.

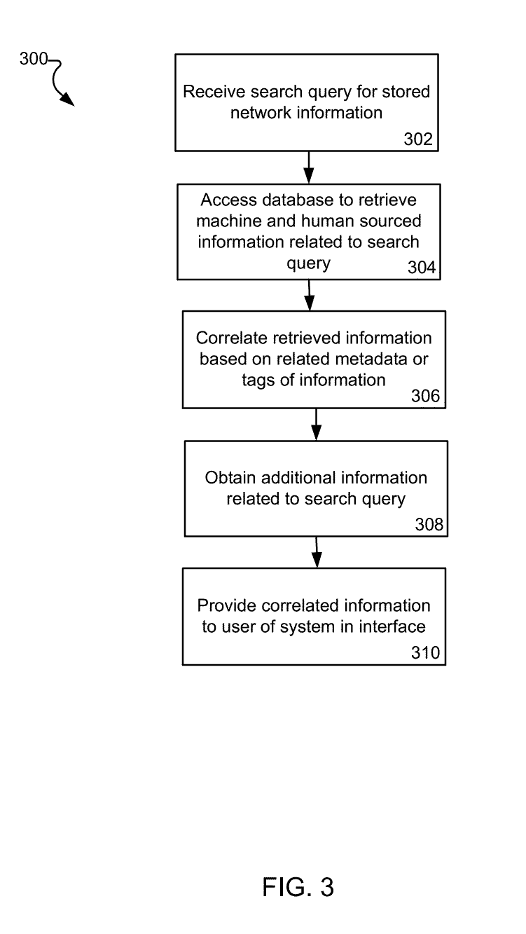

FIG. 3 is a flowchart of a method for providing combined machine-sourced and human-sourced network information to a network administrator utilizing the system 100. In general, the operations of the method 300 of FIG. 3 may be performed by any component of the system 100. In one particular embodiment, the operations are executed by the collector 102 and/or the collaboration components of the system 100. The operations and purpose of the collaboration component is discussed in more detail below.

Beginning in operation 302, the system 100 receives a search query from a user 110 of the system 100 or from a computing device in communication with the system. In one embodiment, the search query is a string of alphanumeric characters entered into a user interface associated with the system 100. Such search queries may be saved for future searches by the system 100. In another embodiment, the search query is generated and transmitted to the system 100 from another computing device to receive one or more data sets about the network from the system. Regardless of how the search query is provided, the search query may include an identification of a device on the network or an event occurring or that has occurred on the network. For example, the search query may include an IP address associated with a port or device of the network. Other identifiers included in the search query may include a Uniform Resource Locator (URL) of a network device, a name associated with the network device by the system 100 or network, a bit string identifying the device, a label applied to a specific or general event occurring or having occurred on the network, and the like. In general, the search query may include information that may aid the system 100 in sorting and obtaining information from the database 108.

In operation 304, the system 100 accesses the database 108 to obtain machine sourced data and human sourced data related to the identifiers in the search query, and in operation 306, the system 100 correlates the retrieved information into a results dataset based at least on the search query. In one embodiment, the system 100 performs a full text search on the stored data with the human sourced data and the machine sourced data handled as a single logical set of data. In other embodiments, the system 100 may utilize the metadata associated with the stored data to improve the results returned from the search query. For example, in one embodiment, a search score may be associated with each retrieved set of data to provide the most relevant results from the search by providing only those results that exceed a baseline search score. In another example, the system 100 may only retrieve those data sets that include a match with an identifier in the search query rather than doing a full text search on all of the data. In this manner, the results of the search query may be provided faster as only a search through the metadata is performed.

In operation 308, the system 100 may obtain one or more additional sets of human sourced or machine sourced data that may not be directly returned in the initial search query or may not score high in the initial search. For example, in one embodiment of the search function, search scoring can be adjusted to increase the weighting of human sourced data that have one or more similar machine record associated. For example, a plurality of similar or identical tokens or metadata elements may be adjusted to include a higher search score. This enhances search quality by finding human comments from the past that may be related, even though they don't hit or score highly on the direct search. Such human sourced data may include stored checklists and/or workflows that have been performed in the past in response to a similar network event as included in the search query, even though such checklists may be directly identified in the search query. Similarly, the scoring on machine sourced data that have a close association to human sourced data can be adjusted to enhance search results by surfacing potentially similar incidents for comparison that wouldn't otherwise have hit in the direct search.

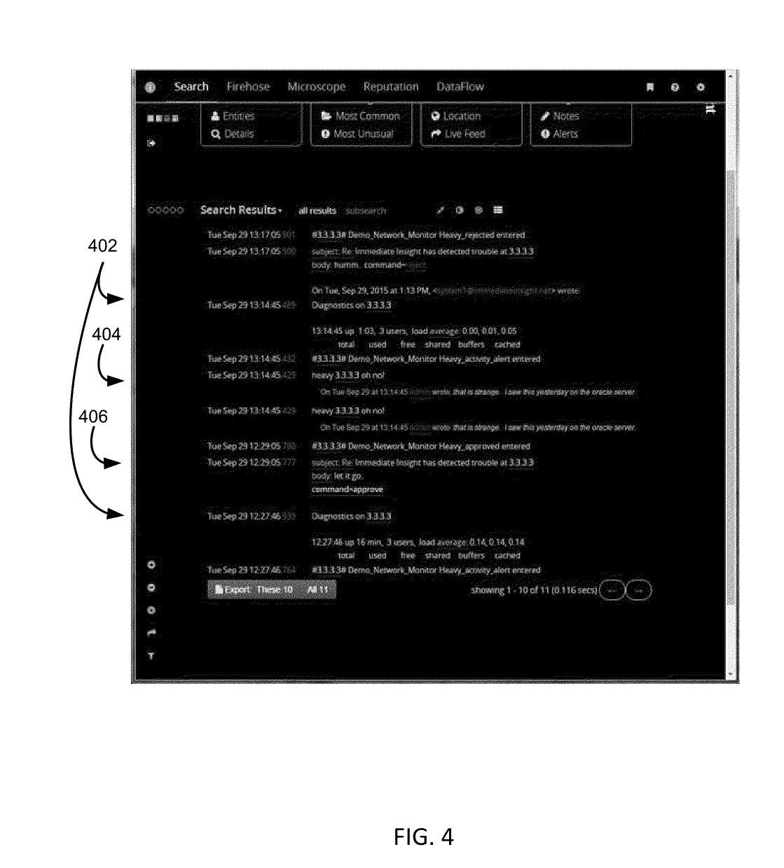

In operation 310, the results 124 of the search on the information stored in the database 108 in response to the search query is provided to the user 110 or the requesting computing device. In one embodiment, the results are provided on a user interface of the system 100. FIG. 4 is an example user interface 400 providing results of combined machine sourced and human sourced network information to a network administrator or other user of the system 100. As shown, the results include information retrieved for an example IP address 3.3.3.3 of a network device. Such information includes both machine sourced data 402 (such as the diagnostic results reported by the device in response to a diagnostic command) and human sourced data, including comments 404 entered into a collaboration system (discussed in more detail below) by a network administrator and an email 406 generated and/or received by the system. In this manner, both machine sourced data 402 and human sourced data 404, 406 are displayed by the system 100 in the user interface through a single search query. In one embodiment, the results displayed in the user interface may be interactive such that a user may select a result to obtain more information from the database 108.

In a similar manner, the information obtained by the system 100 may be provided to a requesting computing device. For example, a monitoring device may be associated with the network. Upon the generation of an alert or other event on the network, the monitoring device may provide a search query to the system 100 to obtain information concerning the network event. The system 100 may provide both human sourced and machine sourced data to the monitoring device in response to the search query. This information may be processed by the monitoring device to respond to the alert, including determining the steps taken by one or more network administrators to remedy the network event.

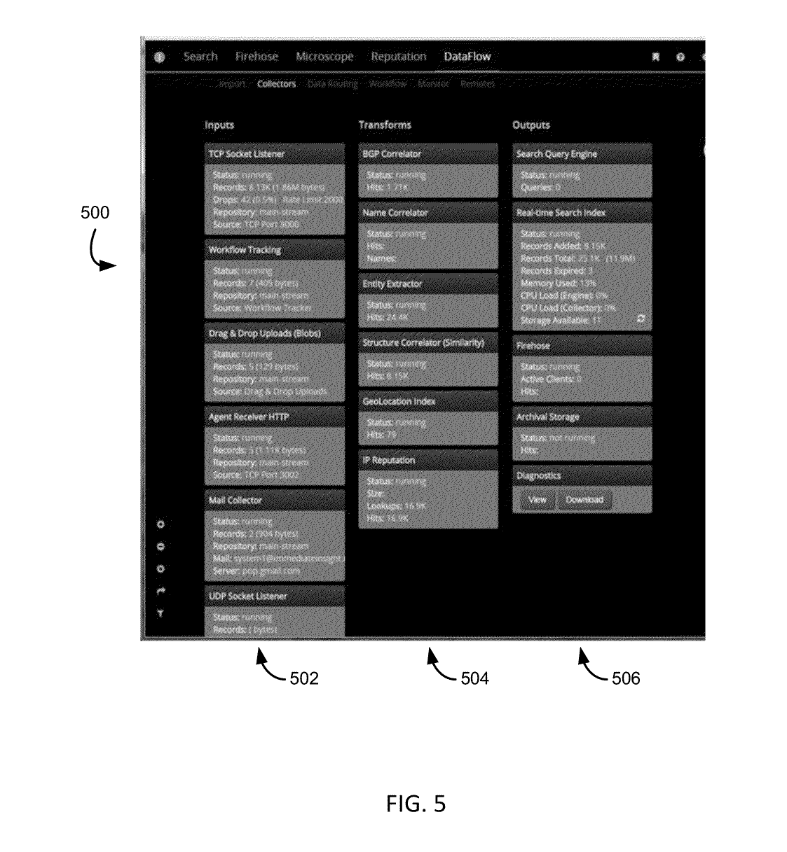

As discussed above, the information obtained and stored by the system 100 may include both human sourced data and machine sourced data. FIG. 5 is an example user interface 500 illustrating a number of sources 502-506 of data stored in a database associated with a network. The sources of information illustrated in the example 500 are just some of the possible sources of data concerning the operation of the network. Further, through the user interface 500, a user of the system 100 may select additional or fewer sources of data to include in the database 108. The sources of data stored in the database 108 are grouped into three groups, namely inputs 502, transforms 504, and outputs 506. However, each group of sources may include both machine sourced data and human sourced data such that both sets of data are treated as a single data source.

By receiving, storing, and making available to a user of the system 100 both human sourced and machine sourced data, the system provides a platform through which users and network administrators may collaborate to address one or more network events. For example, the network may experience an outage or particularly heavy traffic on one or more network devices. This network event may cause one or more of the components of the network to transmit an alarm to a network monitoring device or administrator. To resolve the network issue that generates the alarm, the network administrators may execute one or more remedial actions to place the network back into a normal condition. Through the use of the system 100 described herein, information generated concerning the network event may be obtained, stored, and provided to one or more network administrators to aid the administrators in executing the remedial actions for the network event.

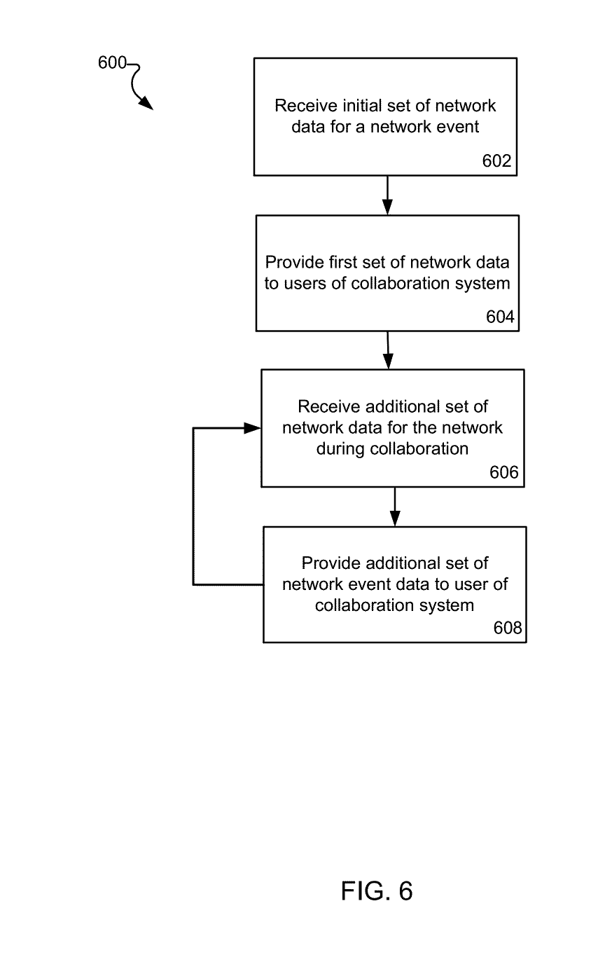

In particular, FIG. 6 is a flowchart of a method for utilizing network information to collaborate on responding to a network event. The operations of the method 600 of FIG. 6 may be performed by a collaboration component 104 of the system 100. Turning to system 100 of FIG. 1, the collaboration component 104 may facilitate one or more collaboration sessions by users 110 of the system 100 to respond to a network event. During a collaboration session, the collaboration component 104 may receive, store, and/or otherwise share user analyzed data 128 between the users 110 of the system and the database 108. This user analyzed data 128 may be presented to users 110 of the system 100 through the user interface such that each user may understand and receive information on the condition of the network.

In particular, beginning in operation 602 of the method 600 of FIG. 6, the system 100 may receive machine sourced data 120 and human sourced data 118 in a similar manner as described above. This information may be associated with a network event or network device and stored in the database 108 by the system 100. Further, the information 118, 120 may be generated from a network event, such as one or more network or device alarms. This information may be referred to as an initial set of network data received at the system 100 from a machine or a human administrator of the network.

In operation 604, the collaboration component 104 or the collector component 102 of the system 100 may provide the combined machine and human sourced data 124 to one or more users 110 of the system. This information 124 may aid the users 110 in determining the nature of the network event and the one or more operations to execute in response to the network event. In one embodiment, the information 124 may include one or more workflows that include the operations to execute to resolve or address the network event. Upon receiving the initial information 124, one or more administrators of the network may generate additional network information, such as emails, instructions to network devices, blog entries discussing the network event, network diagnostic information, workflows, status of tickets, and the like. This additional information may be provided to or otherwise collected by the collector 102 of the system 100 in operation 606. For example, in response to the initial data set, a network administrator 112 may send an email 118 through an email program 114 to another network administrator referencing the network event. This email 118 may be received by the system 100 in a similar manner as described above. In another example, a network administrator may instruct a network device related to the network event to provide a device diagnostic report. The device 116 may, in turn, generate the report 120 and provide the report to the system 100. In this manner, the system 100 may receive additional information or data concerning the network event.

In operation 608, the collaborator component 104 provides the additional network information related to the network event to the one or more users 110 of the system 100. In one particular embodiment, the information is displayed in a user interface of the system 100 as described above. Further, when the additional network event information is provided to the users 110, additional information may be further generated as the administrators and/or devices of the network work through one or more workflows to respond to the network event. Thus, the method 600 may return to operation 606 as more information is generated and to operation 608 as the additional information is also provided to the users 110 of the system 100.

In this manner, one or more users of the system 100 may collaborate through the collaboration component 104 of the system to receive machine sourced and human sourced network data based on a network event and perform one or more remedial actions in response to the event. Referring to FIG. 1, user analyzed data 128 is received from and provided to users 110 of the system 100 and the database 108 to facilitate a collaboration base for the users of the system to address a network event. In addition, as described above, the users 110 of the system 100 may be one or more computing devices that receive information from the system and generate one or more instructions executed on the network in response to the network event. Thus, one or more operations may be automatically executed on the network based on the information collected by and received from the collaboration component 104 of system 100.

Collaboration utilizing the network information obtained by the system 100 may occur as described above. Such collaboration allows human input to be directly associated with one or more machine generated pieces of data and/or allows human input to be loosely associated with one or more machine generated pieces of data. Such human data may inherit the characteristics of the associated data without having a hard link. This allows the human input to be searched independently from the machine data, in some embodiments. Collaboration also enables the creation of shared collaboration sessions each of which can host one or more user's input with each participant being able to view and provide input at any time. User input may include but is not limited to: plain text, sound, video, images, location, URL, reference to stored machine data, new machine data, screencast recording of an activity (may also include keystrokes). Users may also subscribe to a real-time feed of user input and the context of that input, respond to any other user's input while viewing machine data, store all user collaboration input in a way that makes it searchable in the same manner as the machine data, rank or rate the quality of someone's input, share collaboration sessions with other users, live share of user interface screens with other users, allow another user to control the user interface being shared, compare complex data to find a specific difference, and/or export/import sessions to/from 3rd party systems.

As described, the collaboration component 104 of the system 100 allows network administrators to responding to network events. In one embodiment, the response to a network event may include a workflow 128. In general, workflows 128 are an ordered series of one or more operations that network devices, computing devices, or network administrators execute in response to a network event. Such operations may be dependent upon network information, such as the machine sourced and human sourced information stored by the system 100. The workflow component 106 of the system 100 allows the creation and execution of workflows 128 during collaboration by collecting workflow hints from the collaboration methods by direct entry into a user interface, such as users identifying their own or other's input as a workflow step or solution, reordering, editing, and/or deleting their own or other's input. In other embodiments, the workflow component 106 may also collect workflow hints from the collaboration automatically by analyzing past workflows to extrapolate a solution, query an external source of solutions for a best match, apply business rules to the current collaboration session to generate a solution, behavioral characteristics such as search sequences, time on focus, traversal time, and/or particular keys or mouse input. In yet another embodiment, the workflow component 106 may generate sequence confirmation controls (such as a checkbox list) to guide users who are using the workflow and enable the automated playback execution of recorded activities. Changes could include and are not limited by: network wide changes of device configuration, application service configuration, deployment of new services, data acquisition, event reporting, performance monitoring. The system 100 may also run analytics on the workflow to guide its execution, including but not limited to, statistical analysis of related data and comparison to previous runs.

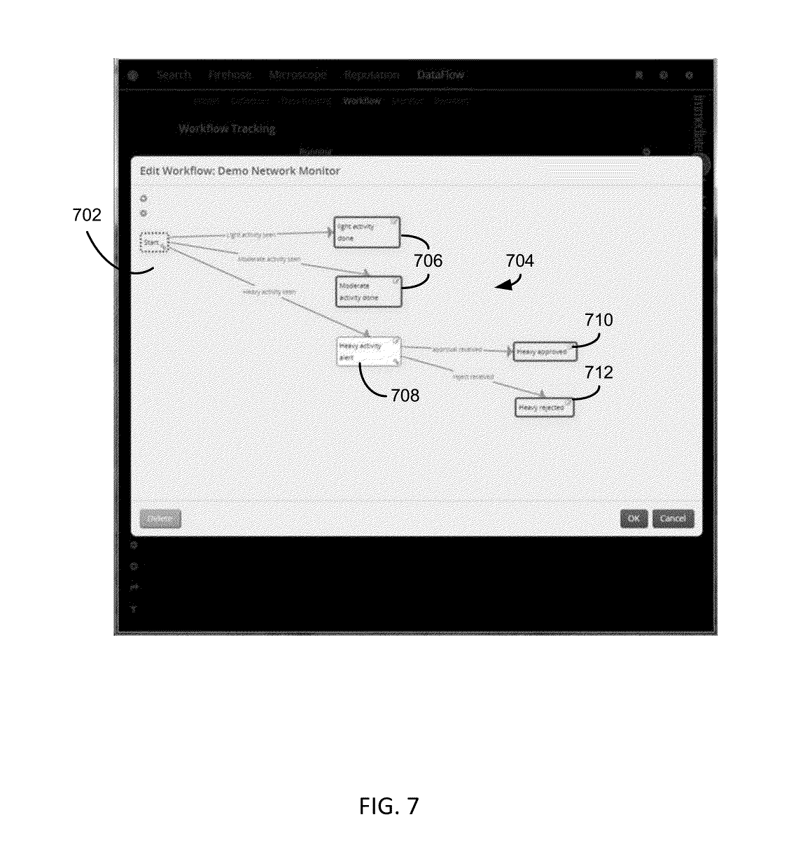

FIG. 7 is an example of a workflow editor user interface 702 for workflow component 106 of system 100. The user interface 702 provides a visual representation of the workflow 704 for a detected network event. In this example, a workflow 704 for maintaining a network is shown. The workflow 704 describes a state machine or flowchart of network actions for an experienced volume of activity at a particular network device. For example, from the start state, a process for light activity, moderate activity, and heavy activity for the device are defined. The activity at the network device may be reported to the system 100 by the network device automatically or in response to a query transmitted to the device. As shown in the example workflow 704, a report of light or moderate activity on the device results in a “done” or completed state 706. However, for heavy activity at the device, an alert is generated at state 708 of the workflow. As described below, the system 100 may perform an action at state 708 and further states 710, 712 of the workflow 704 may be entered based on the results of action. In this manner, the workflow 704 provides business rules 132 for responding to a network event detected on the network, with such rules being automated or performed manually by a network administrator.

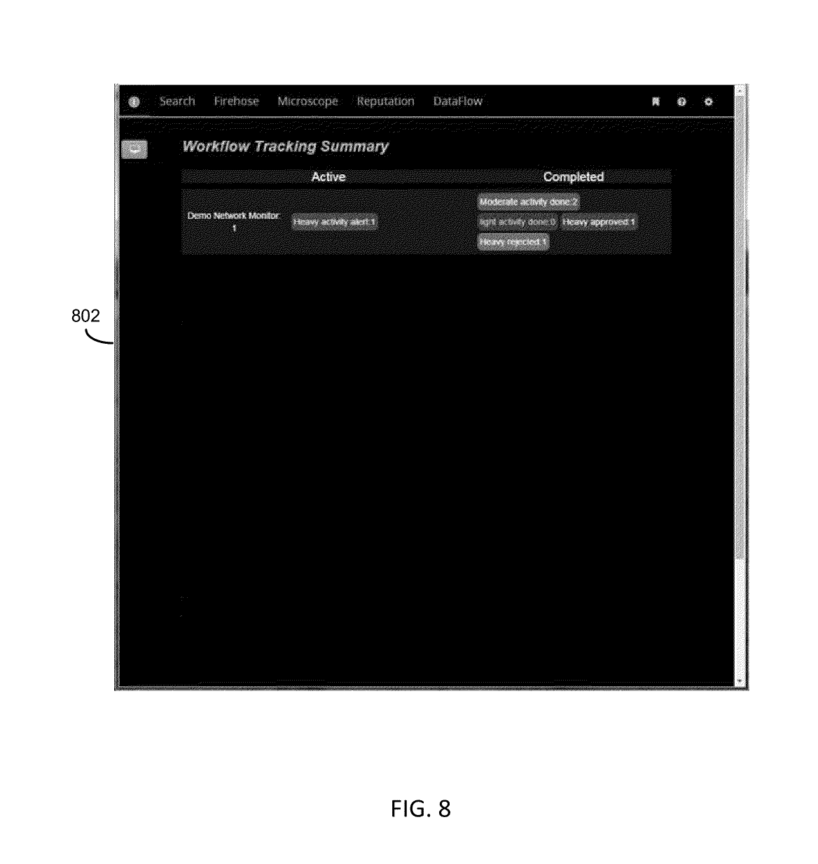

FIG. 8 is one embodiment of a workflow activity summary user interface 802 for workflow component 106 of system 100. User interface 802 may provide an activity summary view for one or more workflows executed by the workflow component 106 of the system 100. In this example, user interface 802 shows a summary of the workflow 704 depicted in user interface 702 by providing identifiers of completed workflows and active workflows in color-coded boxes. In other embodiments of the user interface 802, acidity may be expressed in terms of percent completed, tabular, or chart form.

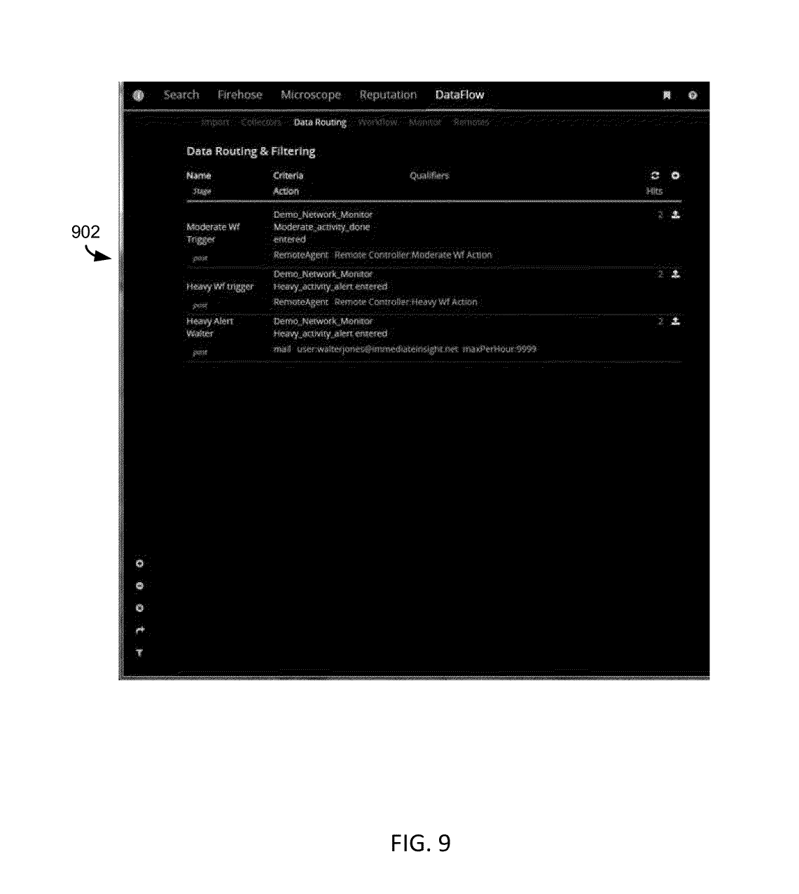

As mentioned above, a workflow executed by the system 100 may cause one or more actions to be performed by the system, by a device of the network or associated with the network, or by one or more human-interaction. FIG. 9 is an example of an action trigger configuration user interface 902 illustrating one or more actions initiated from a workflow for network maintenance. As shown, the workflow 704 of FIG. 7 may cause a reporting agent to query for a diagnostic report from a particular network device to determine the level of activity at the device. This diagnostic information may be received at the system 100, stored in the database 108, and provided to a user of the system through a user interface (such as diagnostic results 402 shown in FIG. 4). In this manner, a workflow 704 may generate machine sourced information of the network that is received and displayed by the system 100. As also shown in FIG. 9, the workflow 704 may cause human sourced information to be provided to the system 100. For example, the workflow 704 of FIG. 4, at state 708, may cause the system 100 or a third party email program to generate an alert email and transmit the alert email to a network administrator. The sent email may be captured by the system 100 and also included in the displayed results of a particular network event. Further, the response provided by the network administrator may causer a workflow state transition based on its content. For example, the workflow 704 moves from state 708 to state 710 when the response contains an approval, or the workflow moves from state 708 to state 712 when the response contains a rejection. Further still, the response provided by the network administrator may be received at the system 100, stored, and provided to a user of the system in the search results for the particular network event.

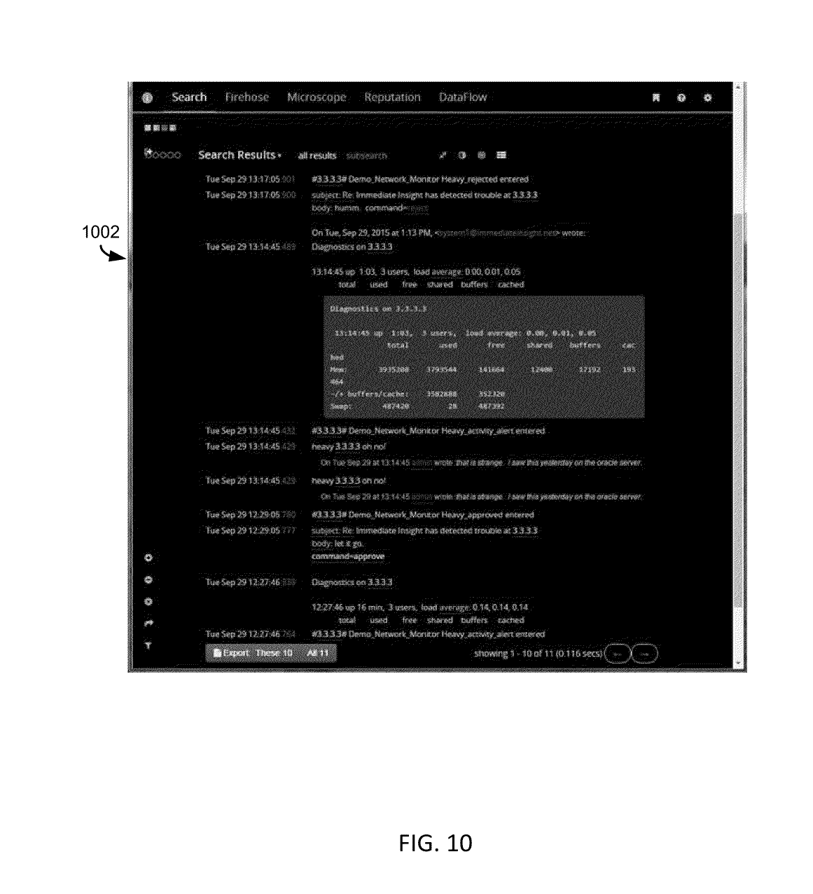

FIG. 10 is an example user interface 1002 illustrating combined machine-sourced and human-sourced network information to a network administrator, including results from one or more automatic actions taken by the system in response to a workflow for network maintenance. The results illustrated in the example are for the workflow 704 discussed above with reference to FIG. 7. In the user interface 1002, both the machine sourced data of the diagnostic report from the particular network device and human sourced data of the email or blog conversation between network administrators are illustrated. In this manner, both machine sourced data and human sourced data related to the particular network device or event may be obtained, stored, and provided to user by the system 100 to collaborate and execute one or more actions in response to the network event.

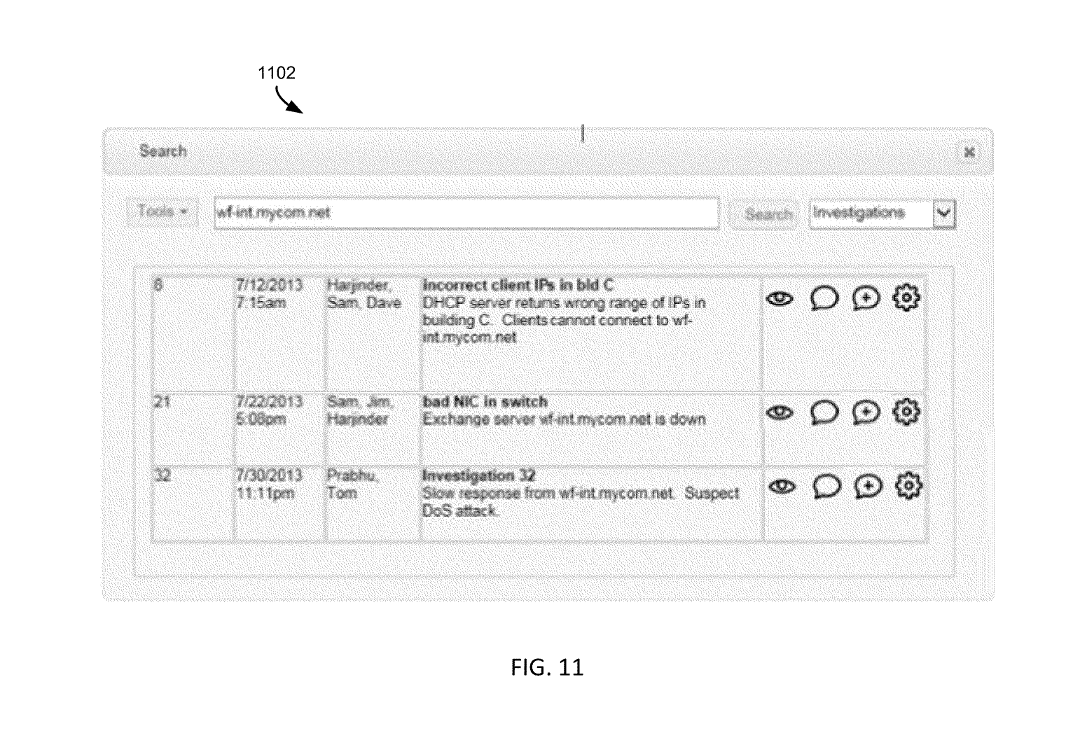

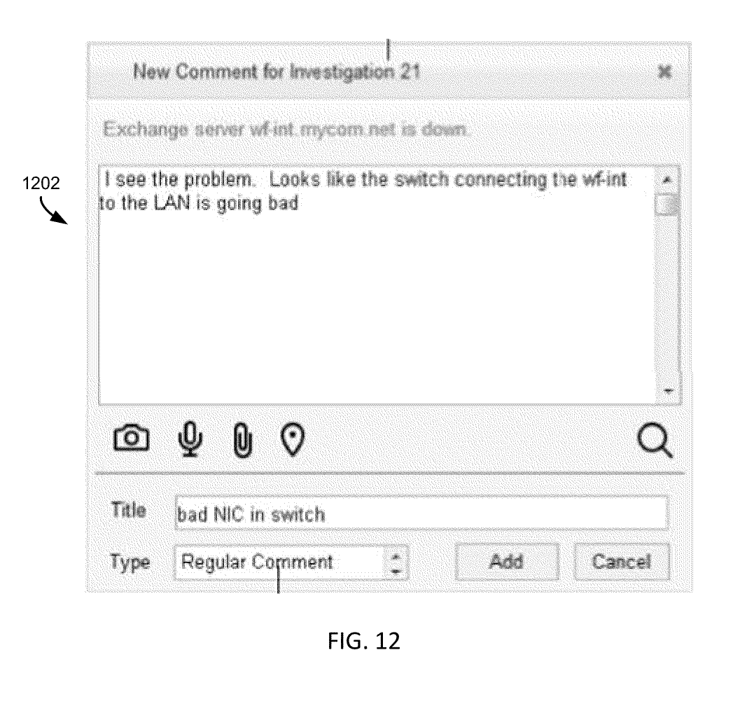

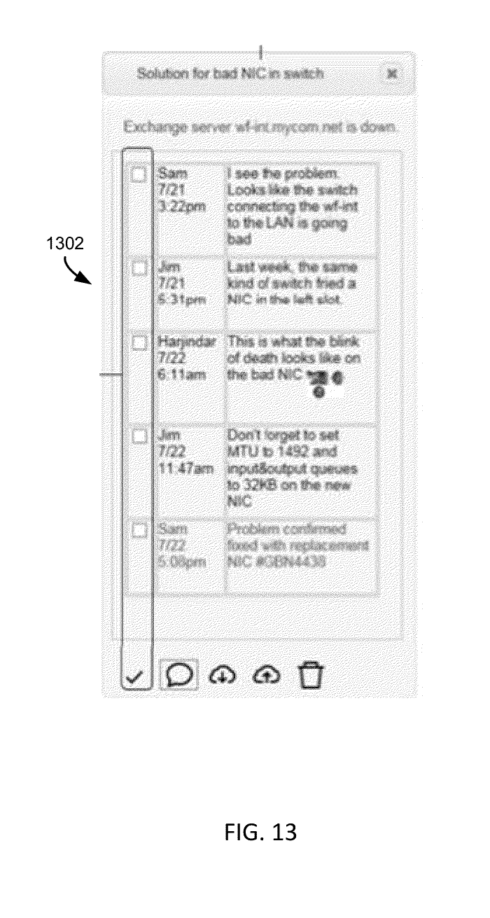

Although the results of the stored data is illustrated in a user interface discussed above, other examples of providing search results of a network event or receiving input from a user of the system 100 is also contemplated. For example, FIG. 11 is a second-type of user interface 1102 providing results of a search of human-sourced network information in a collaboration feature of the user interface, FIG. 12 is a second-type of user interface 1202 for receiving comments in a collaboration feature of the user interface, and FIG. 13 is a second-type of user interface 1302 for providing a checklist for responding to a network event utilizing the system 100 described herein. In general, the user interface to the system 100 may take any form for ease of use and understanding by the users of the system.

Through the described system, human and machine sourced data from a computing network may be integrated into a shared database. The human and machine sourced data is available by one or more network administrators to allow the administrators to collaborate within the combined data set to create and execute one or more solution workflows to respond to events occurring within the network. In one embodiment, the human and machine sourced data is stored in the database as a single data set. In this manner, the data or network information may be searched collectively through one search query applied to the stored data. The workflows may include actions performed automatically by the system in response the detected event as well as actions performed by one or more of the administrators of the network. In one embodiment, one or more workflows may be altered or amended based on noted successes of previous workflows addressing similar events in the network. Thus, through this collaboration and workflow process, the system may identify an event in the network and undertake one or more actions to address the identified event.

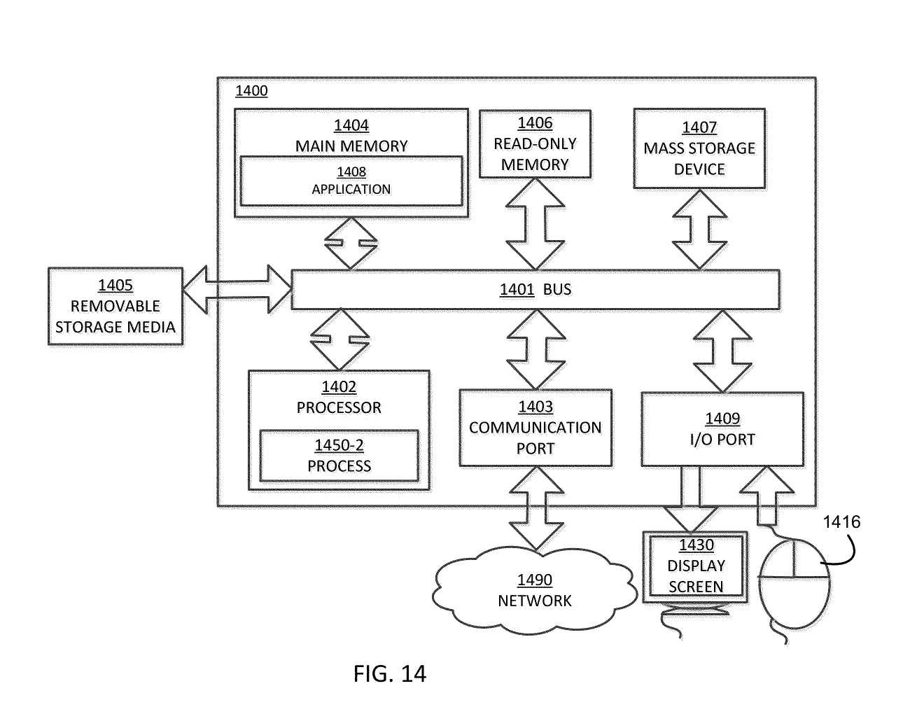

FIG. 14 is an example schematic diagram of a computing system 1400 that may implement various methodologies discussed herein. The computing system for the application 1408 includes a bus 1401 (i.e., interconnect), at least one processor 1402 or other compute element, at least one communication port 1403, a main memory 1404, a removable storage media 1405, a read-only memory 1406, and a mass storage device 1407. Processor(s) 1402 can be any known processor, such as, but not limited to, an Intel® Itanium® or Itanium 2® processor(s), AMD® Opteron® or Athlon MP® processor(s), or Motorola® lines of processors. Communication port 1403 can be any of an RS-232 port for use with a modem based dial-up connection, a 10/100 Ethernet port, a Gigabit port using copper or fiber, or a USB port. Communication port(s) 1403 may be chosen depending on a network 1490 such as a Local Area Network (LAN), a Wide Area Network (WAN), or any network to which the computer system 1400 connects. An executing application may be in communication with peripheral devices (e.g., display screen 1430, input device 1416 via Input/Output (I/O) port 1409.

Main memory 1404 can be Random Access Memory (RAM) or any other dynamic storage device(s) commonly known in the art. Read-only memory 1406 can be any static storage device(s) such as Programmable Read-Only Memory (PROM) chips for storing static information such as instructions for processor 1402. Mass storage device 1407 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices, may be used.

Bus 1401 communicatively couples processor(s) 1402 with the other memory, storage and communications blocks. Bus 1401 can be a PCI/PCI-X, SCSI, or Universal Serial Bus (USB) based system bus (or other) depending on the storage devices used. Removable storage media 1405 can be any kind of external hard drives, thumb drives, Compact Disc-Read Only Memory (CD-ROM), Compact Disc-Re-Writable (CD-RW), Digital Video Disk-Read Only Memory (DVD-ROM), etc.

Embodiments herein may be provided as a computer program product, which may include a machine-readable medium having stored thereon instructions which may be used to program a computer (or other electronic devices) to perform a process. The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages should be understood by the foregoing description, and it should be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it should be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

We claim:

1. A system for managing a computer network, the system comprising:
a communication port for communication with one or more devices of the computer network and one or more third party systems;
a collector component receiving machine sourced information from the one or more devices of the computer network and human sourced information from the one or more third party systems;
a database storing the machine sourced information and the human sourced information in data set of network information, the data set of network information comprising at least one metadata identifier corresponding to a network event; and
a collaboration component accessing the data set of network information of the combined machine sourced information from the one or more devices of the computer network and the human sourced information from the one or more third party systems and providing the data set of network information to a user.

2. The system of claim 1 wherein the collaboration component receives a search query from the user and correlates the search query with the at least one metadata identifier prior to accessing the data set of network information of the combined machine sourced information from the one or more devices of the computer network and the human sourced information from the one or more third party systems.

3. The system of claim 2 further comprising a display device displaying a user interface for receiving the search query from the user and the displaying the combined machine sourced information from the one or more devices of the computer network and the human sourced information from the one or more third party systems and providing the data set of network information to the user.

4. The system of claim 1 wherein the machine sourced information from the one or more devices of the computer network comprises a diagnostic report generated by the one or more devices.

5. The system of claim 1 wherein the human sourced information from the one or more third party systems comprises an email transmitted by an email server.

6. The system of claim 1 wherein the one or more devices of the computer network are associated with an Internet Protocol (IP) address and the collector component further detects the IP address in the received machine sourced information from the one or more devices of the computer network and human sourced information from the one or more third party systems.

7. The system of claim 6 wherein the metadata identifier comprises the associated IP address of the one or more devices of the computer network.

8. The system of claim 1 wherein the network event is associated with an alert to a network administrator generated by the one or more devices of the computer network.

9. The system of claim 1 further comprising a workflow component automatically executing one or more business rules in response to the network event.

10. The system of claim 9 wherein the execution of the one or more business rules occurs upon the receipt of a human generated response from the one or more third party systems.

11. A method for managing a network of computing devices, the method comprising:
receiving, at a collector component of a network management system, machine sourced information from one or more devices of the network of computing devices and human sourced information from the one or more third party systems in communication with the network management system;
correlating the received machine sourced information and human sourced information to a particular network event;
storing the received machine sourced information from one or more devices of the network of computing devices and human sourced information from the one or more third party systems in communication with the network management system in a database a data set of network information;
receiving a search query from a user of the network management system;
accessing the data set of network information of the combined machine sourced information from the one or more devices of the computer network and the human sourced information from the one or more third party systems based on the received search query; and
providing the data set of network information to the user of the network management system.

12. The method of claim 11 further comprising:
associating at least one metadata identifier corresponding to the particular network event with the received machine sourced information from one or more devices of the network of computing devices and human sourced information from the one or more third party systems.

13. The method of claim 12 further comprising:
analyzing the received machine sourced information from one or more devices of the network of computing devices and human sourced information from the one or more third party systems for data corresponding to the at least one metadata identifier.

14. The method of claim 13 wherein the one or more devices of the network of computing devices are associated with an Internet Protocol (IP) address and the metadata identifier comprises the associated IP address of the one or more devices of the computer network.

15. The method of claim 11 further comprising:
displaying the data set of network information to the user of the network management system utilizing a display device of the network management system.

16. The method of claim 11 wherein the machine sourced information from the one or more devices of the network of computing devices comprises a diagnostic report generated by the one or more devices.

17. The method of claim 11 wherein the human sourced information from the one or more third party systems comprises an email transmitted by an email server.

18. The method of claim 11 wherein the network event is associated with an alert to a network administrator generated by the one or more devices of the network of computing devices.

19. The method of claim 18 further comprising:
automatically executing at least one business rule of a workflow in response to receiving the alert from the one or more devices of the network of computing devices.
